(19) United States
(12) Patent Application Publication
(10) Pub. No.: US 2017/0079267 A1
(43) Pub. Date: Mar. 23, 2017

(54) SEX PHEROMONE COMPOSITION OF PEACH FRUIT MOTH AND ATTRACTANT COMPRISING THE SAME

(71) Applicant: SHIN-ETSU CHEMICAL CO., LTD., Tokyo (JP)

(72) Inventors: Tatsuya Fujii, Niigata-ken (JP); Kazunori Funazaki, Niigata-ken (JP); Yuki Miyake, Niigata-ken (JP); Miyoshi Yamashita, Niigata-ken (JP)

(21) Appl. No.: 15/259,500

(22) Filed: Sep. 8, 2016

Related U.S. Application Data
(63) Continuation of application No. 13/491,249, filed on Jun. 7, 2012, now abandoned.

(30) Foreign Application Priority Data
Jun. 17, 2011 (JP) 2011-135171
Jan. 30, 2012 (JP) 2012-017007

(51) Int. Cl. A01N 35/02; A01N 27/00

(52) U.S. Cl. CPC A01N 35/02; A01N 27/00

(57) ABSTRACT

Provided are a novel sex pheromone composition of peach fruit moth which is expected to be used in emergence forecast, mass trapping and mating disruption and has higher attractiveness than that of conventional sex pheromone compositions; and a sex attractant, a mating disruptant and a control method comprising the novel sex pheromone composition as an active ingredient. Specifically provided are a novel sex pheromone composition of peach fruit moth comprising (Z)-7-tricosene and (Z)-13-eicosen-10-one, a sex attractant and a mating disruptant comprising this sex pheromone composition, and a method for controlling peach fruit moth using this sex pheromone composition.

### CROSS REFERENCE TO RELATED APPLICATIONS

This application is a continuation of U.S. application Ser. No. 13/491,249, filed Jun. 7, 2012, which claims priority from Japanese Application No. 2011-135171, filed Jun. 17, 2011 and Japanese Application No. 2012-017007, filed Jan. 30, 2012, the entire contents of which are incorporated herein by reference.

### BACKGROUND OF THE INVENTION

1. Field of the Invention

The present invention relates to a sex pheromone composition of peach fruit moth (Carposina sasakii), which is an orchard pest, and an attractant, a mating disruptant and a control method comprising or using the composition.

2. Description of the Related Art

The peach fruit moth is an important insect pest of rosaceous orchard trees such as apples and peaches. Since larvae burrow into fruits, the allowable level of damage is low, and the larvae which have burrowed therein cannot be controlled by a pesticide. Although this species is univoltine or bivoltine per year, the season of emergence varies widely and adults emerge continuously from June to September. Accordingly, constant spraying of a pesticide is necessitated. On the other hand, it is desirable to minimize spraying of a pesticide from the viewpoint of food safety and environmental load. Therefore, it is important to develop a novel controlling technique as an alternative to spraying of a pesticide.

As the controlling technique as an alternative to spraying of a pesticide, pest control of using pheromones may be exemplified. For example, sex pheromone traps are widely used for the emergence forecast of lepidopteran insect pests. Sex pheromones are chemical substances that are emitted by female adults, and show an attracting action in a species-specific manner toward male adults of the same species. By finding the chemical composition of a sex pheromone and using it as an attractant, it becomes possible to conduct an efficient investigation of emergence. Since the emergence forecast enables control in an appropriate time, prevention of excess spraying of a pesticide is expected. Furthermore, it is also possible to control insect pests using this sex pheromone composition by a mass trapping method by which mass males are trapped, or a mating disruption method by which the mating behavior between male and female is disrupted.

The sex pheromone composition of peach fruit moth was identified to be a 20:1 (weight ratio) mixture of (Z)-13-eicosen-10-one and (Z)-12-nonadecen-9-one (Tamaki et al., Applied Entomology and Zoology. 12 (1): 60-68 (1977), and Honma et al., Jpn. J. Appl. Entomol. Zool. 22 (2): 87-91 (1978)). Since then it has been found that no reproducibility is observed in the sex pheromone activity of the second component (Z)-12-nonadecen-9-one, while this species is not attracted by an attractant which comprises neither (Z)-13-eicosen-10-one nor (Z)-12-nonadecen-9-one (Shirasaki et al., Jpn. J. Appl. Entomol. Zool., 23(4): 240-245 (1979) and Han et al., Journal of Asia-Pacific Entomology, 3(2): 83-88 (2000)). Based on these findings, it is considered that use of a single component of (Z)-13-eicosen-10-one is practical for attracting this species, and a single component of (Z)-13-eicosen-10-one is used as an active ingredient in current sex pheromone traps and mating disruptants of this species.

However, sex pheromone traps for the peach fruit moth have lower attractiveness as compared to those for the other lepidopteran insect pests, and in some cases, the peach fruit moth is not trapped despite that adults have emerged. Therefore, development of a sex pheromone trap having higher attractiveness has been strongly desired. Furthermore, since this species is an insect pest that is subjected to export control and the allowable level of damage thereof is extremely strict, development of a control method having a higher controlling effect has been desired strongly.

### SUMMARY OF THE INVENTION

The present invention has been made in view of the above-mentioned circumstances, and aims at providing a novel sex pheromone composition of peach fruit moth (Carposina sasakii) which is expected to be used in emergence forecast, mass trapping and mating disruption and has higher attractiveness than that of conventional sex pheromone compositions, and a sex attractant, a mating disruptant and a control method comprising or using this composition as an active ingredient.

The present inventors have found that the attractiveness is dramatically increased by adding a novel sex pheromone substance which has been identified in the present invention to a single component of (Z)-13-eicosen-10-one which has been conventionally reported as a sex pheromone substance of peach fruit moth, and completed the present invention.

According to the present invention, a sex pheromone composition of peach fruit moth comprising (Z)-7-tricosene and (Z)-13-eicosen-10-one, and a sex attractant and a mating disruptant comprising this sex pheromone composition as an active ingredient are provided. A method for controlling the peach fruit moth using the sex pheromone composition, such as the method comprising a step of releasing the sex pheromone composition into a field, is also provided.

According to the present invention, a sex attractant which is effective for specifically attracting more male adults of peach fruit moth so as to know a more detailed circumstance of emergence can be obtained. Furthermore, it is also possible to directly control this species in applications to mass trapping, mating disruption and the like.

### BRIEF DESCRIPTION OF THE DRAWINGS

FIGS. 1A and 1B shows an EAD (electroantennographic detection) chart of the extract of peach fruit moth in FIG. 1(A), and GC (gas chromatography) chart of the extract of peach fruit moth in FIG. 1(B);

FIG. 2 shows a mass spectrum of the component (1) in the extract of peach fruit moth;

FIG. 3 shows a mass spectrum of the component (2) in the extract of peach fruit moth;

FIG. 4 shows a mass spectrum of the component (3) in the extract of peach fruit moth;

FIG. 5 shows a mass spectrum of the component (4) in the extract of peach fruit moth;

FIG. 6 shows a mass spectrum of the component (5) in the extract of peach fruit moth;

FIG. 7 shows a mass spectrum of the component (6) in the extract of peach fruit moth;

FIG. 8 shows a mass spectrum of a commercial product docosane;

FIG. 9 shows a mass spectrum of a commercial product tricosane;

FIG. 10 shows a mass spectrum of a synthesized compound (Z)-7-tricosene;

FIG. 11 shows a mass spectrum of a synthesized compound (Z)-5-pentacosene;

FIG. 12 shows a mass spectrum of a synthesized compound (Z)-12-nonadecen-9-one;

FIG. 13 shows a mass spectrum of a synthesized compound (Z)-7-heneicosen-11-one; and

FIG. 14 shows a white adhesive-type trap.

### DETAILED DESCRIPTION OF THE PREFFERED EMBODIMENTS

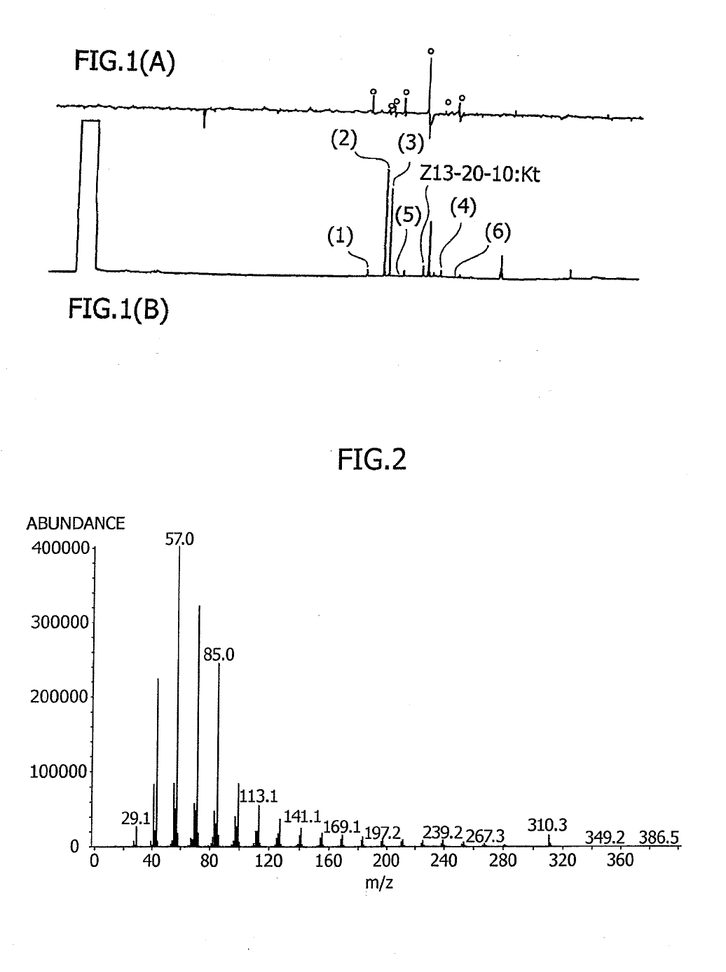

An EAD chart of the extract of peach fruit moth (Carposina sasakii) is shown in FIG. 1A and a GC chart of the extract is shown in FIG. 1B. In the extract, seven components which are components (1) to (6) and (Z)-13-eicosen-10-one (also abbreviated as “Z13-20-10: Kt”) and for which the antenna of a male adult on 3 to 5 days after eclosion shows a potential response, have been found. In FIG. 1B, the peaks for components (5) and (6) were at the detection limit or less so that they were not detected. As a result of analyses of these components in the extract by GC-MS, it was found that the components (1) to (6) were docosane, tricosane, (Z)-7-tricosene, (Z)-5-pentacosene, (Z)-12-nonadecen-9-one and (Z)-7-heneicosen-11-one, respectively, and the mixing weight ratio thereof was 6:341:432:36:2:8 relatively to 100 of (Z)-13-eicosen-10-one.

The sex pheromone composition of peach fruit moth (Carposina sasakii) of the present invention comprises (Z)-7-tricosene and (Z)-13-eicosen-10-one.

(Z)-7-tricosene can be synthesized through a cross-coupling reaction between 1-bromodecane and a Grignard reagent obtained by reacting an alkenyl chloride (Z)-7-tridecenyl chloride with metal magnesium in tetrahydrofuran.

(Z)-13-eicosen-10-one can be synthesized according to, for example, JP 55-59129A.

Although the mixing ratio of (Z)-7-tricosene and (Z)-13-eicosen-10-one is not specifically limited as long as it is within a range at which a male adult shows a response, it is preferably from 10:100 to 10000:100, more preferably from 100:100 to 1000:100, still more preferably from 200:100 to 800:100 in terms of weight ratio.

In addition to (Z)-7-tricosene and (Z)-13-eicosen-10-one, the sex pheromone composition of peach fruit moth of the present invention can optionally comprise one or more selected from the group consisting of docosane, tricosane, (Z)-12-nonadecen-9-one, (Z)-5-pentacosene and (Z)-7-heneicosen-11-one, which are other components in the above-mentioned extract.

Commercially available docosane and tricosane can be used as they are.

(Z)-12-nonadecen-9-one can be synthesized by a reaction between nonanoic acid anhydrous and a Grignard reagent obtained by reacting an alkenyl chloride (Z)-3-decenyl chloride with metal magnesium in tetrahydrofuran.

(Z)-5-pentacosene can be synthesized by a cross-coupling reaction between known 1-bromotridecane and a Grignard reagent obtained by reacting an alkenyl chloride (Z)-7-dodecenyl chloride with metal magnesium in tetrahydrofuran.

(Z)-7-heneicosen-11-one can be synthesized by a reaction between undecanoic acid anhydrous prepared from known undecanoic acid and a Grignard reagent obtained by reacting a known alkenyl chloride of (Z)-3-decenyl chloride with metal magnesium in tetrahydrofuran.

The content of one or more selected from the group consisting of docosane, tricosane, (Z)-5-pentacosene, (Z)-12-nonadecen-9-one and (Z)-7-heneicosen-11-one is, for example, as follows. The docosane, tricosane, (Z)-5-pentacosene, (Z)-12-nonadecen-9-one and (Z)-7-heneicosen-11-one are preferably from 0.1 to 100, from 100 to 1,000, from 1 to 100, from 0.1 to 100 and from 0.1 to 100, respectively, and more preferably from 1 to 10, from 300 to 400, from 30 to 40, from 1 to 10 and from 1 to 10, respectively, relative to 100 of (Z)-13-eicosen-10-one in terms of a weight ratio.

An antioxidant such as butylhydroxytoluene, butylhydroxyanisole, hydroquinone or Vitamin E, and/or an ultraviolet absorbent such as 2-hydroxy-4-octoxybenzophenone, or 2-(2′-hydroxy-3′-tertbutyl-5′-methylphenyl)-5-chlorobenzotriazole can be added to the sex attractant or mating disruptant comprising the sex pheromone composition of peach fruit moth according to the present invention. For example, an amount of the antioxidant is 1 to 5% by weight and an amount of the ultraviolet absorber is 1 to 5% by weight relatively to the total weight of (Z)-7-tricosene and (Z)-13-eicosen-10-one.

The sex attractant and the mating disruptant of the present invention may be in any form and not particularly limited as long as they can release a predetermined amount of the active ingredient sustainedly for a long period. They may be used after placing the sex pheromone composition in a container such as a cap, a tube, a laminate bag, a capsule or an ampule made of a material cable of controlling an amount of release such as rubber, polyethylene, polypropylene, ethylene-vinyl acetate copolymer or polyvinyl chloride.

As for the sex attractant, although the amount of the sex pheromone composition in the container is not specifically limited as long as it shows attractive activity, it is preferably in the range of, for example, 10 μg to 100 mg. As for the mating disruptant, although the amount of the sex pheromone composition in the container is not particularly limited as long as a pheromone concentration in the outside air at which males cannot pick out the pheromone of females can be ensured, it is preferably, for example, 10 mg or more per preparation.

The sex pheromone composition can be used for a method of controlling peach fruit moth. For example, the method includes at least placing the sex attractant or mating disruptant in a field.

### EXAMPLES

Hereinafter, the present invention will be explained in detail based on Examples. It should not be construed that the present invention is limited to or by Examples.

<Preparation of Extract of Peach Fruit Moth (Carposina sasakii)>

When the mating time zone of peach fruit moth was investigated under breeding conditions of a constant temperature of 25° C. and a photocycle of a light period of 16 hours and a dark period of 8 hours, it was found that peaks of the calling behavior and mating time zone were present at 5 to 6 hours after starting of the dark period. In this time zone, the pheromone gland was excised from a virgin female adult (2 to 3 days old) under a microscope and immersed in n-hexane for 30 minutes. Then the insect body tissues were removed from the extraction liquid by filtration to produce an extract of peach fruit moth.

### <Analysis of Extract of Peach Fruit Moth>

A GC-EAD (Gas Chromatography-Electroantennographic Detection) chart of the above extract of peach fruit moth is shown in FIG. 1.

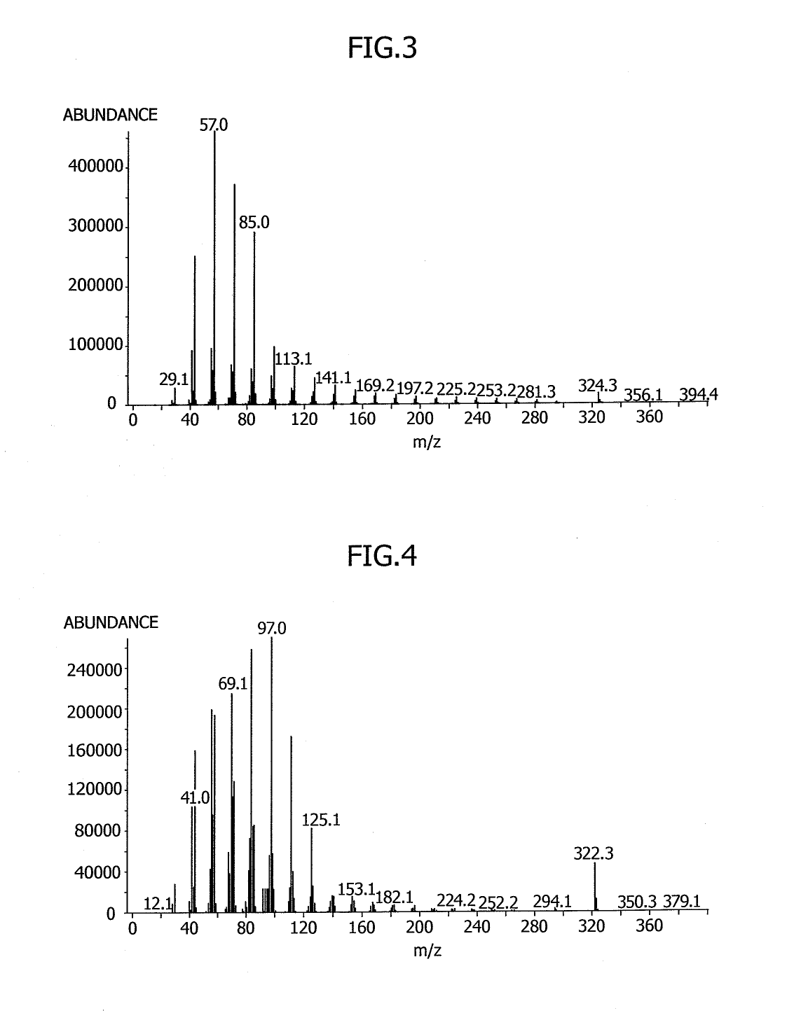

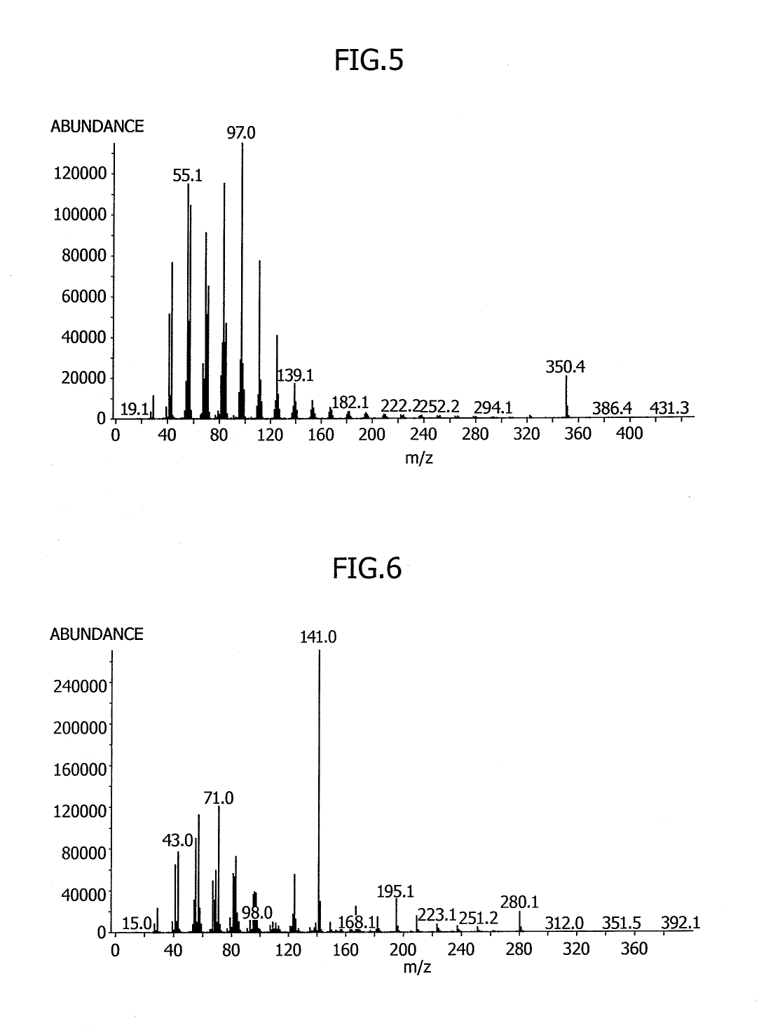

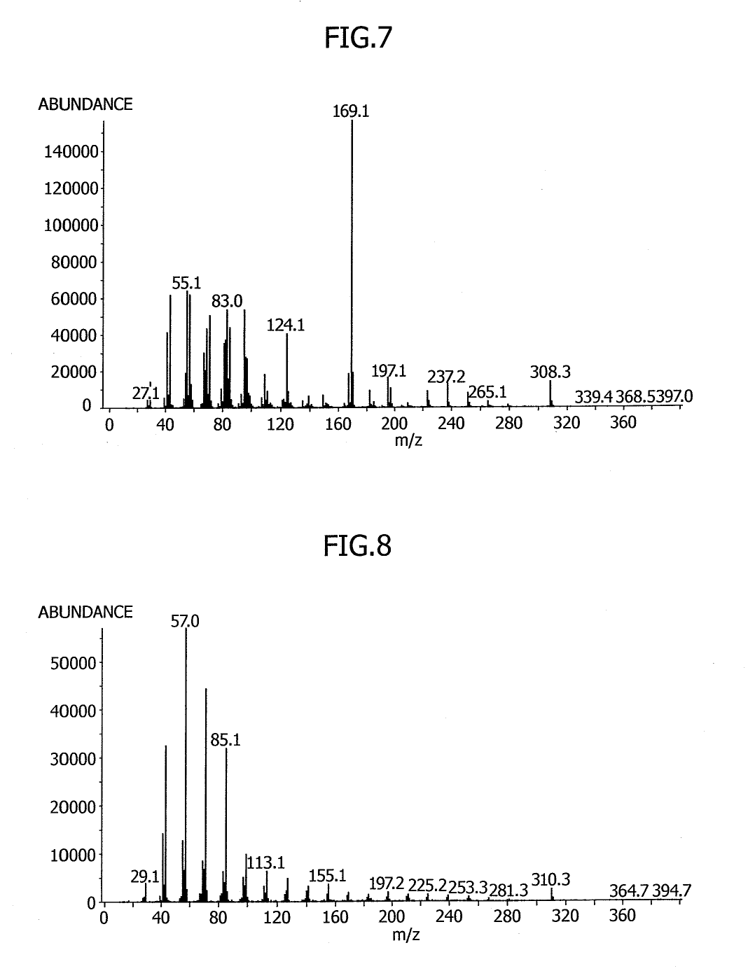

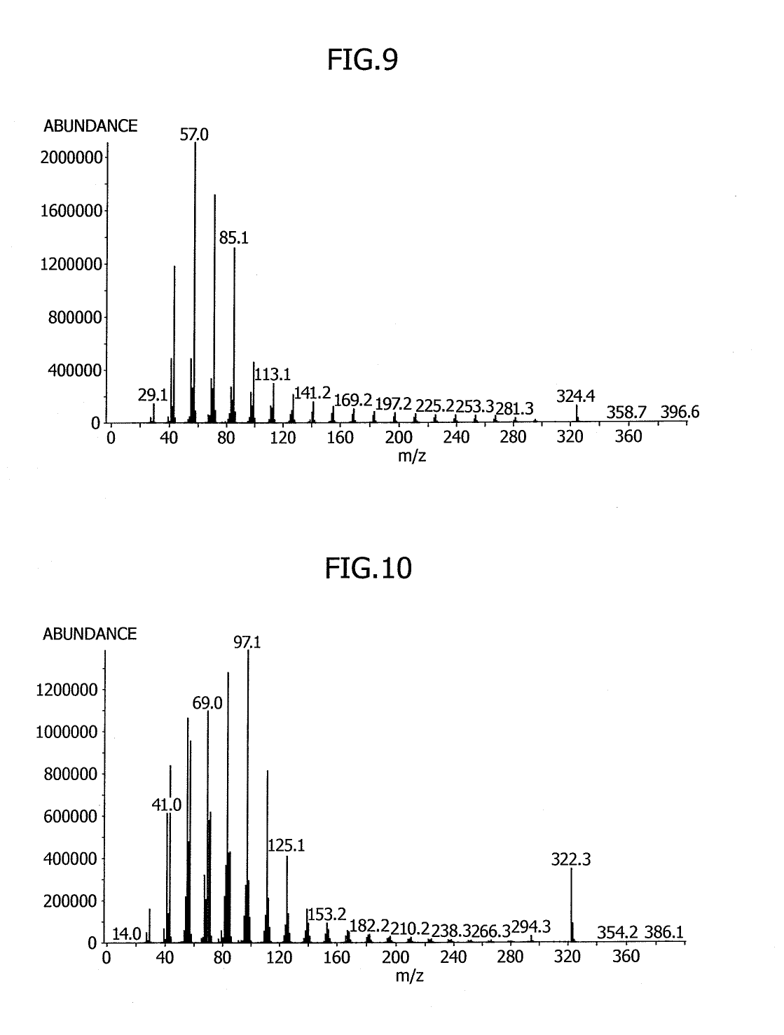

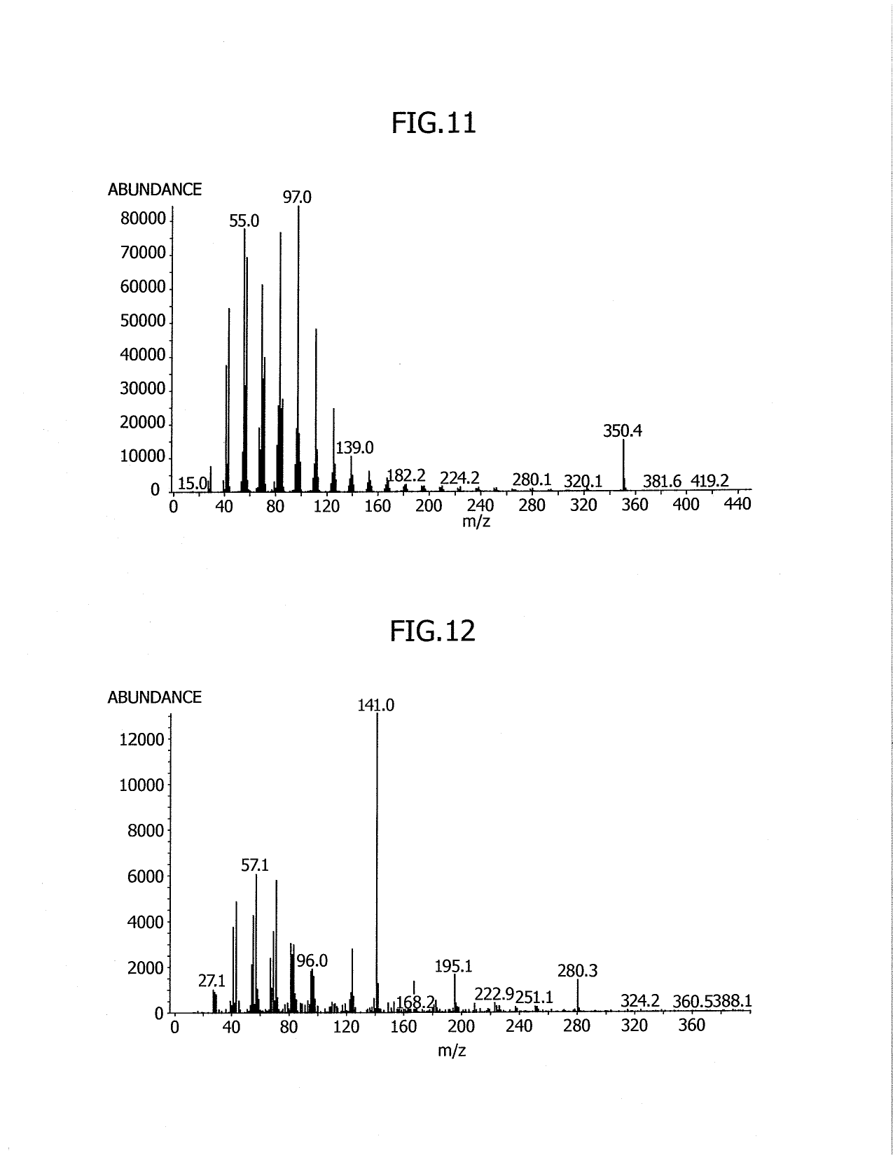

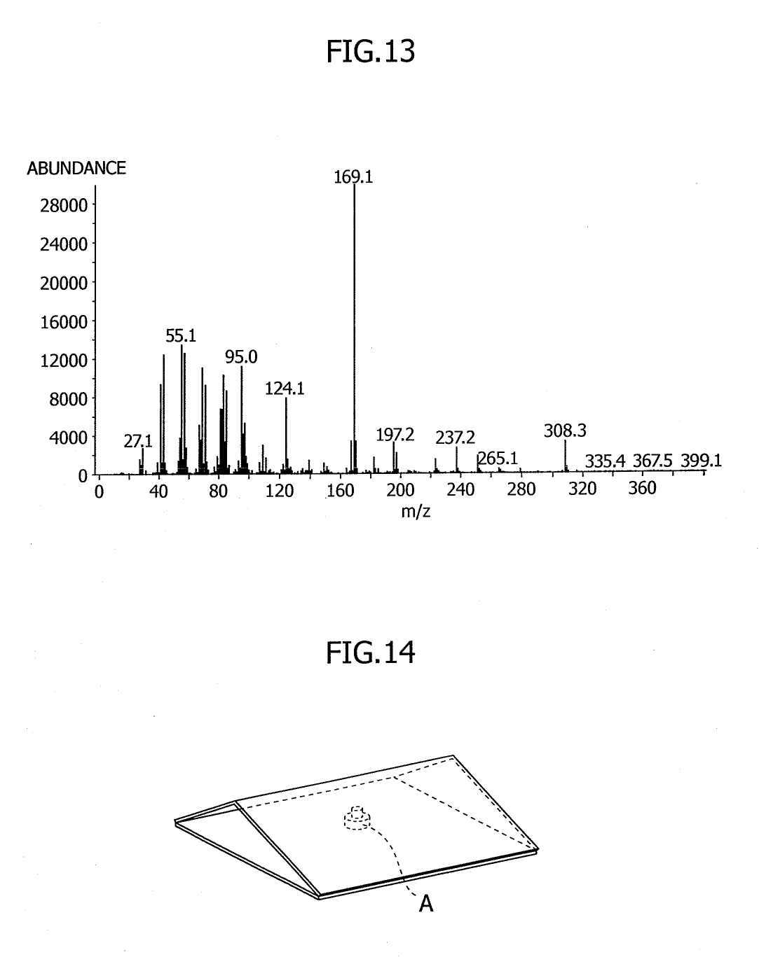

Seven components, components (1) to (6) and (Z)-13-eicosen-10-one, for which the antenna of a male adult showed a potential response were found in the extract. As a result of analyses of these components in the extract by GC-MS, it was found that the components (1) to (6) are normal hydrocarbons, monoene hydrocarbons or monoene ketones. Structural analyses of dimethyl disulfide (DMDS) adducts was conducted for each of the unsaturated bond sites of the monoene components. Finally, it was found in comparison with the retention times and mass spectra of the corresponding synthesized products that the components (1) to (6) were docosane, tricosane, (Z)-7-tricosene, (Z)-5-pentacosene, (Z)-12-nonadecen-9-one and (Z)-7-heneicosen-11-one, respectively, and the mixing weight ratio thereof was 6:341:432:36:2:8 with respect to 100 of (Z)-13-eicosen-10-one. FIGS. 2 to 7 show the mass spectra of the components (1) to (6) in the extract of peach fruit moth, while FIGS. 8 to 13 show the mass spectra of the commercial products and synthesized compounds.

### Examples 1 and 2, and Comparative Example 1

(Z)-7-tricosene and (Z)-13-eicosen-10-one were mixed at the naturally existing weight ratio of 432:100 for peach fruit moth, and 5.32 mg of the mixed two components were placed in a rubber cap made of isoprene to produce an Attractant of Example 1.

In addition, synthesized compounds of (Z)-13-eicosen-10-one, docosane, tricosane, (Z)-7-tricosene, (Z)-5-pentacosene, (Z)-12-nonadecen-9-one and (Z)-7-heneicosen-11-one were mixed in the same manner at the naturally existing weight ratio of 100:6:341:432:36:2:8, and 9.25 mg of the mixture was placed in a rubber cap in the same manner to produce an Attractant of Example 2.

Furthermore, only one component (Z)-13-eicosen-10-one was placed in a rubber cap to produce an Attractant of Comparative Example 1.

Each attractant was left overnight and attached to a white adhesive-type trap. As shown in FIG. 14, the white adhesive-type trap comprises a roof and a bottom plate, and an opening for invasion of insects is made narrow. Furthermore, an adhesive substance is attached to the upper surface of the bottom plate, and an attractant A is directly mounted on the adhesive surface. Thus, the trap has a structure which allows only insects that have approached the attractant to be trapped, but does not allow the other insects to enter into the trap as much as possible.

Each trap with an attractant was installed in an orchard where peach fruit moth inhabited. The number of the male adults which had been trapped in each trap was measured on every two or three days. The total number of male adults trapped in the Attractant of Example 1 was regarded as 100, while the numbers of male adults trapped in other attractants were expressed as relative values to said 100. The results thereof are shown in Table 1.

TABLE 1

| | | | | | | | | total number of |
|---|---|---|---|---|---|---|---|---|
| | mixed weight ratio of | | | | | | | adult males |
| | synthesized pheromones *1 | | | | | | | trapped |
| | Z13- | | | | | | | (relative |
| | 20-10:Kt | (1) | (2) | (3) | (4) | (5) | (6) | values) |
| Example 1 | 100 | — | — | 432 | — | — | — | 100 |
| Example 2 | 100 | 6 | 341 | 432 | 36 | 2 | 8 | 68 |
| Comp. | 100 | — | — | — | — | — | — | 9 |
| Ex. 1 | | | | | | | | |

*1 “Z13-20-10:Kt” represents (Z)-13-eicosen-10-one and (1) to (6) represent the following: (1): docosane, (2): tricosane, (3): (Z)-7-tricosene, (4): (Z)-5-pentacosene, (5): (Z)-12-nonadecen-9-one, and (6): (Z)-7-heneicosene-11-one.

The number of male adults of peach fruit moth trapped in the trap with the Attractant of Example 1 was ten or more times as many as the number of male adults trapped in the trap with the Attractant of Comparative Example 1. The difference was also statistically significant. Since the attractiveness was enhanced significantly by addition of (Z)-7-tricosene to (Z)-13-eicosen-10-one, it is evident that the mixture of these two components is a sex pheromone composition of this species.

Significantly more male adults were trapped in the trap with the Attractant of Example 2 in comparison with the trap with the Attractant of Comparative Example 1. Furthermore, although the number of adults trapped in the trap with the Attractant of Example 2 was slightly small in comparison with that of adults trapped in the trap with the Attractant of Example 1, the difference was not statistically significant. Accordingly, it is evident that the attractiveness was increased also by the presence of (Z)-7-tricosene with respect to the Attractant of Example 2, and that the other components of docosane, tricosane, (Z)-5-pentacosene, (Z)-12-nonadecen-9-one and (Z)-7-heneicosen-11-one affected little on the attractiveness.

### Example 3 and Comparative Examples 2 to 3

(Z)-7-tricosene and (Z)-13-eicosen-10-one were mixed at the naturally existing weight ratio of 432:100 of peach fruit moth, and 65 mg of the mixture of these two components was placed in a polyethylene tube to produce a Mating Disruptant of Example 3.

In addition, 65 mg of one component (Z)-13-eicosen-10-one was placed in a polyethylene tube to produce a Mating Disruptant of Comparative Example 2.

In an apple orchard where the peach fruit moth inhabited, the Mating Disruptant of Example 3 was installed with a density of 150 disruptants per 10 ares before emergence of adults of wintering generation. This orchard was referred to as a peach fruit moth-controlled orchard of Example 3.

In addition, the Mating Disruptant of Comparative Example 2 was installed in an apple orchard in the same manner as the above, and the apple orchard was referred to as a peach fruit moth-controlled orchard of Comparative Example 2.

Furthermore, an apple orchard where a mating disruptant was not installed at all was referred to as a peach fruit moth-controlled orchard of Comparative Example 3. The ratio of the fruits damaged by peach fruit moth in each apple orchard was investigated in the picking season of apples. The results thereof are shown in Table 2. The percentage of the damaged fruits can be calculated from the equation:

{(number of damaged fruits)/(number of investigated fruits)}×100.

The number of the investigated fruits was 16,949 fruits.

TABLE 2

| | mixed weight ratio of | | percentage of |
|---|---|---|---|
| | synthesized pheromones | | damaged fruits |
| | (Z)-13-eicosen-10-one | (z)-7-tricosene | (%) |
| Example 3 | 100 | 432 | 26.8 |
| Comp. Ex. 2 | 100 | — | 40.1 |
| Comp. Ex. 3 | — | — | 86.4 |

The percentage of the damaged fruits in the peach fruit moth-controlled orchard of Example 3 was 26.8%, which was far lower than 40.1% for Comparative Example 2 and 86.4% for Comparative Example 3. Since the mating disruption effect was enhanced significantly by addition of (Z)-7-tricosene to (Z)-13-eicosen-10-one, it is evident that the mixture of these two components exhibits an excellent performance in the control of this species.

1. A composition for attracting or mating-disruptating peach fruit moth, the composition comprising (Z)-7-tricosene and (Z)-13-eicosen-10-one, and further comprising an effective amount of an antioxidant and/or an effective amount of an ultraviolet absorbent, wherein the composition comprises 10 to 10000 parts by weight of the (Z)-7-tricosene relative to 100 parts by weight of the (Z)-13-eicosen-10-one.

2. The composition according to claim 1, wherein the amount of the antioxidant is 1 to 5% by weight relative to a total amount of the (Z)-7-tricosene and (Z)-13-eicosen-10-one.

3. The composition according to claim 1, wherein the amount of the ultraviolet absorbent is 1 to 5% by weight relative to a total amount of the (Z)-7-tricosene and (Z)-13-eicosen-10-one.

4. The composition according to claim 1, further comprising one or more selected from the group consisting of docosane, tricosane, (Z)-12-nonadecen-9-one, (Z)-5-pentacosene and (Z)-7-heneicosen-11-one.

5. A method for controlling peach fruit moth, comprising a step of releasing, into a field, sex pheromone substances from a composition comprising the sex pheromone substances of (Z)-7-tricosene and (Z)-13-eicosen-10-one, and further comprising an effective amount of an antioxidant and/or an effective amount of an ultraviolet absorbent, wherein the composition comprises 10 to 10000 parts by weight of the (Z)-7-tricosene relative to 100 parts by weight of the (Z)-13-eicosen-10-one.

6. The method for controlling peach fruit moth according to claim 5, wherein the amount of the antioxidant is 1 to 5% by weight relative to a total amount of the (Z)-7-tricosene and (Z)-13-eicosen-10-one.

7. The method for controlling peach fruit moth according to claim 5, wherein the amount of the ultraviolet absorbent is 1 to 5% by weight relative to a total amount of the (Z)-7-tricosene and (Z)-13-eicosen-10-one.

8. The method for controlling peach fruit moth according to claim 5, wherein the composition further comprises one or more selected from the group consisting of docosane, tricosane, (Z)-12-nonadecen-9-one, (Z)-5-pentacosene and (Z)-7-heneicosen-11-one.
